(19) United States
(12) Patent Application Publication
(10) Pub. No.: US 2012/0176286 A1
(43) Pub. Date: Jul. 12, 2012

(54) Dielectric loaded shorted bicone antenna with laterally extending ground plate

(75) Inventors: Anthony K. Amert, Rapid City, SD (US); Keith W. Whites, Rapid City, SD (US)

(73) Assignee: South Dakota School of Mines and Technology, Rapid City, SD (US)

(21) Appl. No.: 12/080,283

(22) Filed: Apr. 2, 2008

(51) Int. Cl. H01Q 13/04

(52) U.S. Cl. 343/773

(57) ABSTRACT

A bicone antenna, having: a tapered top cone; a tapered bottom cone; a laterally extending ground plate beneath the tapered bottom cone; at least one shorting pin connecting the tapered top cone and the tapered bottom cone; a central pin connected to the tapered top cone; a coaxial feed connected to central pin and the laterally extending ground plate; and a dielectric disposed between the tapered top cone and the tapered bottom cone.

### FEDERAL FUNDING

The present invention was funded by the Army Research Laboratory through Cooperative Agreement DAAD19-02-2-0011 with the South Dakota School of Mines and Technology. The government may have certain rights in this invention.

### TECHNICAL FIELD

The present invention relates to antennae in general and to ultrawide band frequency bicone antennae in particular.

### BACKGROUND OF THE INVENTION

The need exists for an inexpensive, commercially viable ultra wide band antenna. Such an antenna would be very suitable in Certified Wireless (UWB), Bluetooth and Winmedia applications. It would be especially desirable if such an antenna is capable of meeting the demands of large bandwidths (from 3.1 GHz to 10.6 GHz), while exhibiting a stable radiation pattern over the frequency band required by the communication technique. It would also be desirable that such an ultra wide band antennae be capable of being integrated into existing structures and objects, while minimizing the height added by the antenna itself.

To date, however, ultra wide band antennae have tended to be large, bulky and relatively delicate structures. In addition, a common problem to existing antennae is that innovations to provide a large bandwidth typically cause the radiation pattern to vary greatly with frequency.

### SUMMARY OF THE INVENTION

In one preferred embodiment, the present invention provides a bicone antenna, comprising: a tapered top cone; a tapered bottom cone; a laterally extending ground plate beneath the tapered bottom cone; a central pin connected to the tapered top cone; and a coaxial feed connected to central pin and the laterally extending ground plate. In various embodiments, it is preferred that only the bottom cone is connected to such a laterally extending ground plate.

The bicone antenna may optionally comprise one or more shorting pins connecting the tapered top cone and the tapered bottom cone, and a dielectric disposed between the tapered top cone and the tapered bottom cone. The top and bottom cones and the central pin may be made of a high-conductivity metal including, but not limited to, copper, aluminum, brass or silver. The dielectric may be made of a material having a dielectric constant that may optionally be between 2 and 2.6. In one exemplary embodiment, the dielectric has a dielectric constant of 2.2. It is to be understood, however, that the present invention is not limited to materials having any particular dielectric constant. Suitable materials for the present dielectric include, but are not limited to, polypropylene, polyethylene, acrylonitrile butadiene styrene, and polystyrene.

In preferred embodiments, the laterally extending ground plate is circular. Also in preferred embodiments, the top and bottom cones have a taper angle from 15 to 35 degrees, the bicone antenna has a total height less than 20 mm, and the laterally extending ground plate has a diameter less than 65 mm. In one exemplary embodiment, the taper angle is about 30 degrees.

The present invention also provides a bicone antenna, comprising: a tapered top cone; a tapered bottom cone; a central pin connected to the tapered top cone; a coaxial feed connected to central pin and the laterally extending ground plate; and a dielectric disposed between the tapered top cone and the tapered bottom cone.

The present bicone antenna is ideally suited for ultra wideband applications, and it exhibits a stable radiation pattern over a wide frequency band. Another advantage of the present antenna is that it maintains good impedance matching.

Another advantage of the present antenna is that is small, very short in height and very compact. In addition, the present antenna is very rugged, and capable of performing well in harsh environments without additional mechanical shielding. As such, an advantage of the present antenna is that it can be easily attached to an existing structure, such as a vehicle or a soldier's helmet.

Other advantages of the present antenna are that its relatively large ground plane dramatically reduces the system's lowest frequency of operation, and that its shorting pins operate to reduce the system's lowest frequency of operation. In addition, the optional dielectric between the top and bottom cones adds both mechanical stability and thus permits overall size reduction. As such, the present invention provides an antenna having maximized bandwidth with reduced overall size.

In addition, the present antenna can be made by low cost plastic injection molding and dipping. As such, it can be easily and cheaply mass produced.

In various embodiments, the present invention comprises: a tapered top cone; a tapered bottom cone; a central pin connected to the tapered top cone; a coaxial feed connected to central pin and to the laterally extending ground plate; and a dielectric disposed between the tapered top cone and the tapered bottom cone.

In yet other embodiments, the present invention comprises: a tapered top cone; a tapered bottom cone; a laterally extending ground plate beneath the tapered bottom cone, and no laterally extending ground plate above the tapered top cone; a central pin connected to the tapered top cone; and a coaxial feed connected to central pin and to the laterally extending ground plate.

### BRIEF DESCRIPTION OF THE DRAWINGS

FIG. 1 is a perspective view of the antenna according to the present invention.

FIG. 2 is a side election view of the antenna of FIG. 1.

FIG. 3 is a top plan view of the antenna of FIGS. 1 and 2.

FIG. 4 is a sectional side election view of the antenna of FIGS. 1 to 3.

FIG. 5 is a cross section of a standard truncated bicone antenna.

FIG. 6 is an illustration of the simulated S₁₁ of the antenna of FIG. 5 as the taper angle is varied.

FIG. 7 is an illustration of the input impedance vs. frequency characteristics of the antenna of FIG. 5 as the taper angle is varied.

FIG. 8 is an illustration of the simulated S₁₁ of the antenna of FIG. 5 as the gap between the top and bottom cones is varied.

FIG. 9 is an illustration of the input impedance vs. frequency characteristics of the antenna of FIG. 5 as the gap between the top and bottom cones is varied.

FIG. 10 is an illustration of the simulated S₁₁ of the antenna of FIG. 5 as the cone length is varied.

FIG. 11 is an illustration of the simulated elevation gain pattern of the antenna of FIG. 5 as the cone length is varied.

FIG. 12 is a sectional side elevation view of a bicone antenna having a laterally extending ground plane in accordance with the present invention.

FIG. 13 is an illustration of the simulated S₁₁ of the antenna of FIG. 12 for different dimensions of the laterally extending ground plane.

FIG. 14 is a is a sectional side elevation view of a bicone antenna having both a laterally extending ground plane, and a plurality of shorting pins in accordance with the present invention.

FIG. 15 is an illustration of the simulated S₁₁ of the antenna of FIG. 14 (compared to one having a ground plate of infinite dimensions).

FIG. 16 is an illustration of the simulated and measured S parameters of an antenna manufactured in accordance with the present invention (i.e. as seen in FIGS. 1 to 4).

FIG. 17 is an illustration of the simulated and measured VSWR of an antenna manufactured in accordance with the present invention (i.e. as seen in FIGS. 1 to 4).

FIG. 18 is an illustration of the simulated and measured elevation gain pattern of an antenna manufactured in accordance with the present invention (i.e. as seen in FIGS. 1 to 4) at 3 GHz.

FIG. 19 is an illustration of the simulated and measured elevation gain pattern of an antenna manufactured in accordance with the present invention (i.e. as seen in FIGS. 1 to 4) at 6 GHz.

FIG. 20 is an illustration of the simulated and measured elevation gain pattern of an antenna manufactured in accordance with the present invention (i.e. as seen in FIGS. 1 to 4) at 9 GHz.

FIG. 21 is an illustration of the simulated and measured elevation gain pattern of an antenna manufactured in accordance with the present invention (i.e. as seen in FIGS. 1 to 4) at 11 GHz.

FIG. 22 is an illustration of the simulated and measured azimuthal gain pattern of an antenna manufactured in accordance with the present invention (i.e. as seen in FIGS. 1 to 4) at 3 GHz.

FIG. 23 is an illustration of the simulated and measured azimuthal gain pattern of an antenna manufactured in accordance with the present invention (i.e. as seen in FIGS. 1 to 4) at 6 GHz.

FIG. 24 is an illustration of the simulated and measured azimuthal gain pattern of an antenna manufactured in accordance with the present invention (i.e. as seen in FIGS. 1 to 4) at 9 GHz.

FIG. 25 is an illustration of the simulated and measured azimuthal gain pattern of an antenna manufactured in accordance with the present invention (i.e. as seen in FIGS. 1 to 4) at 11 GHz.

### DETAILED DESCRIPTION OF THE DRAWINGS

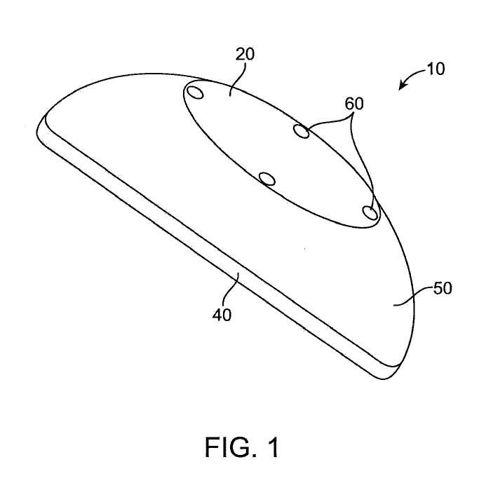

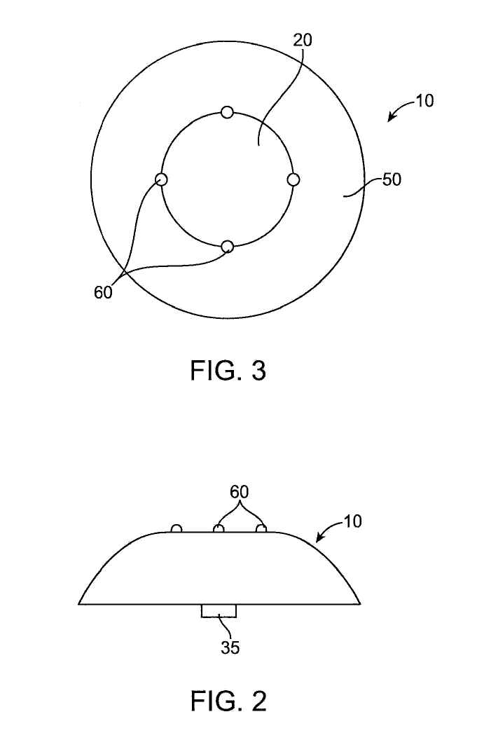

FIGS. 1 to 4 illustrate a preferred embodiment of the present invention.

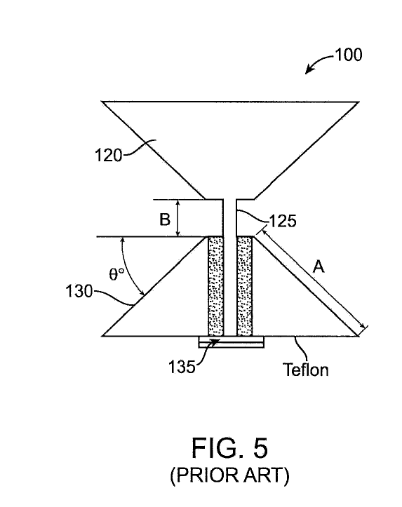

FIGS. 5 to 11 illustrate a standard bicone antenna of various dimensions and characteristics.

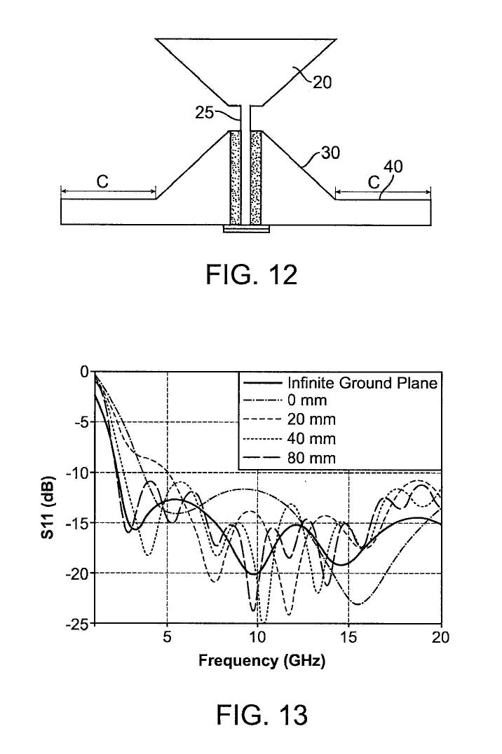

FIGS. 12 to 15 illustrate various dimensions and characteristics of a bicone antenna in accordance with present invention.

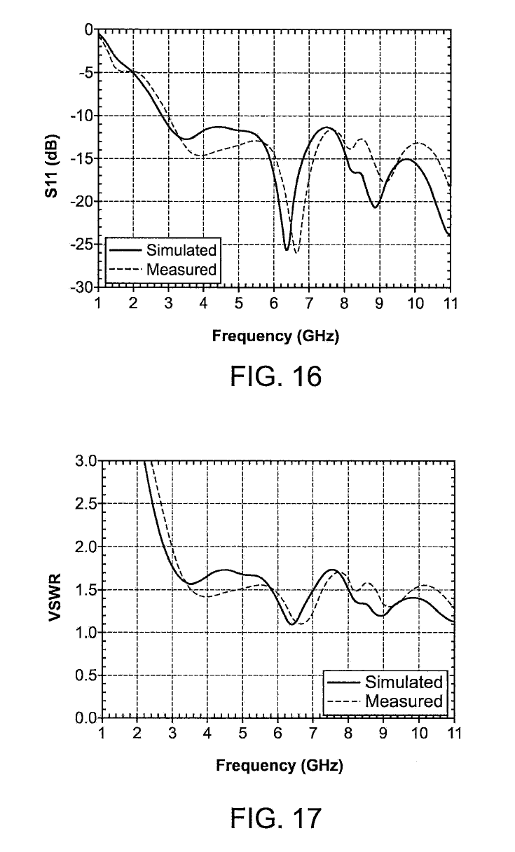

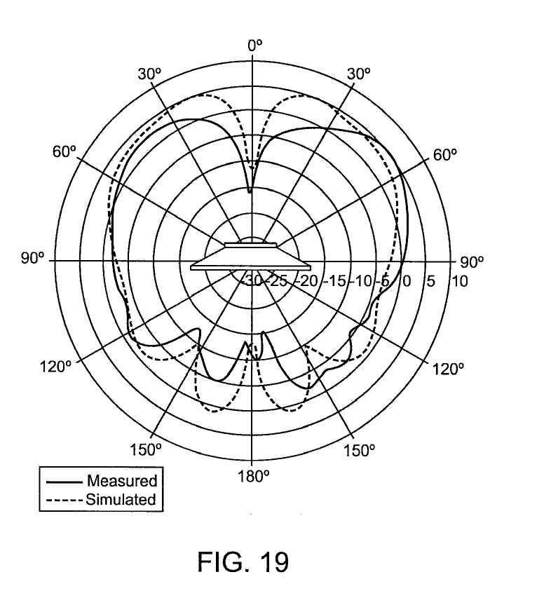

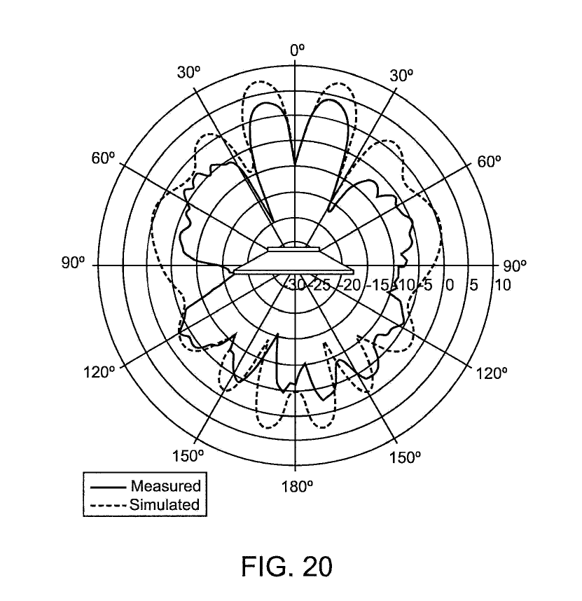

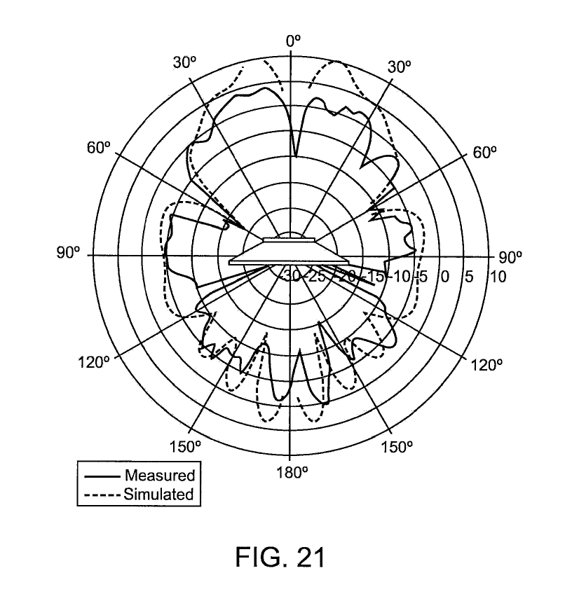

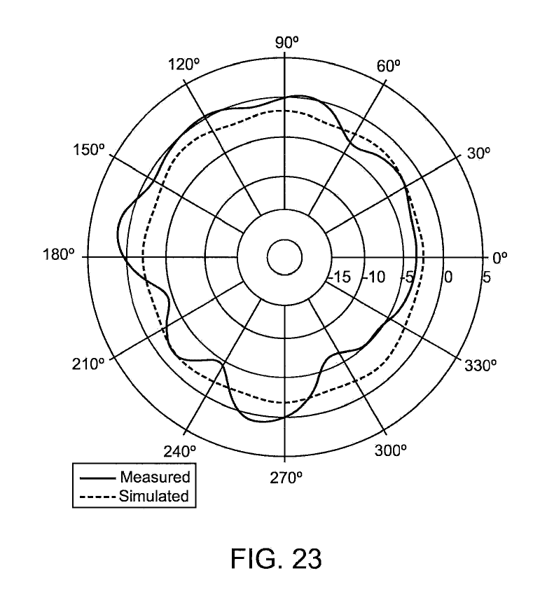

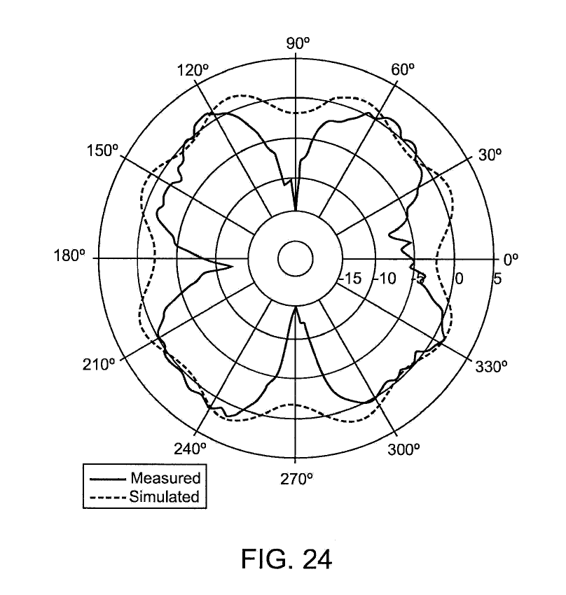

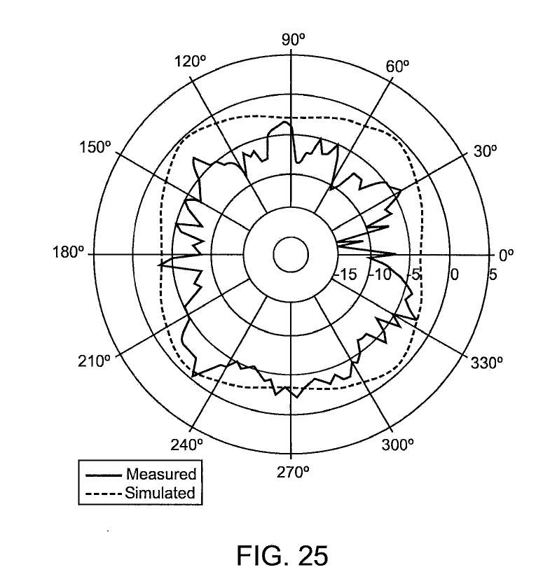

FIGS. 16 to 25 illustrate various simulated and measured characteristics of the antenna in accordance with the present invention (as seen in FIGS. 1 to 4).

Turning first to FIGS. 1 to 4, the present invention provides a bicone antenna 10, comprising: a tapered top cone 20; a tapered bottom cone 30; a laterally extending ground plate 40 beneath tapered bottom cone 30; a central pin 25 connected to tapered top cone 20; a coaxial feed 35 connected to central pin 25 and to laterally extending ground plate 40; and a dielectric 50 disposed between tapered top cone 20 and tapered bottom cone 30.

Also preferably provided are at least one shorting pin 60 connecting tapered top cone 20 and tapered bottom cone 30. As seen in FIG. 3, four shorting pins 60 may be positioned at 90° intervals around a central axis A of bicone antenna 10.

In preferred embodiments, laterally extending ground plate 40 is circular and has a diameter of less than 65 mm.

In preferred embodiments, top and bottom cones 20 and 30 and central pin 25 are made of a high-conductivity metal including, but not limited to, copper, aluminum, brass or silver. Dielectric 50 may optionally comprise polypropylene, polyethylene, acrylonitrile butadiene styrene, or polystyrene.

In optional preferred embodiments, bicone antenna may have one or more of the following dimensions: top and bottom cones 20 and 30 may have a taper angle from 15 to 35 degrees; bicone antenna 10 may have a height less than 20 mm; and laterally extending ground plate 40 may have a diameter less than 65 mm. It is to be understood, however, that these dimensions are merely exemplary, and that the present invention is not limited to any particular dimensions.

Turning next to FIGS. 5 to 11, a standard bicone antenna of various dimensions and characteristics is illustrated. FIGS. 5 to 11 illustrate sequential experimental steps made by the present inventor in the design of the present bicone antenna. As such, FIGS. 5 to 11 are not limiting of the various embodiments of the present invention. Rather, they are included to illustrate steps in the evolution of the present novel antenna design. Thus, FIGS. 5 to 11 are included to fully explain the novel features of the present invention.

FIG. 5 is a cross sectional view of a standard truncated bicone antenna 100 having a top cone 120, a bottom cone 130, a central pin 125 and a coaxial feed 135. Bicone antenna 100 has a taper angle θ, a gap B and a cone length A. In the design of the present antenna, dimensions θ, B and A were varied as set forth below.

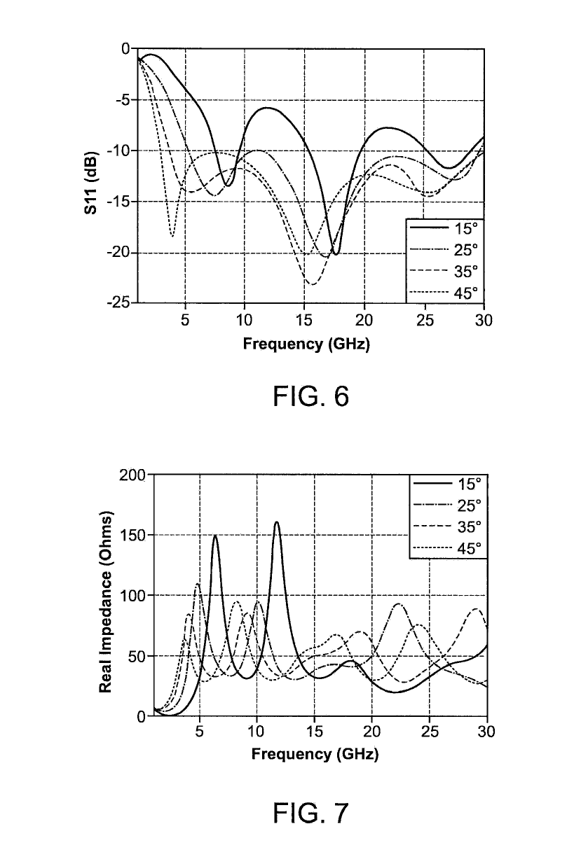

The gap B was held constant at 1 mm and the cone length A was held constant at 15 mm while the taper angle θ was swept from 15° to 35°. The resulting simulated S₁₁ is plotted in FIG. 6. After about 35°, the match across the band deteriorates. FIG. 7 shows the corresponding input impedance and frequency characteristics. As can be seen, sweeping taper angle θ from small to moderate values reduces the periodic local maximum valuesto less than 80 Ω. After taper angle θ passes 35°, the local maximum near 7.5 GHz begins to climb and pushes the impedance matching past acceptable limits after 45°. Under these conditions, taper angle θ was chosen to be 35°. (However, an alternate choice could have been 45° for the 2.4 GHz to 3.4 GHz band.)

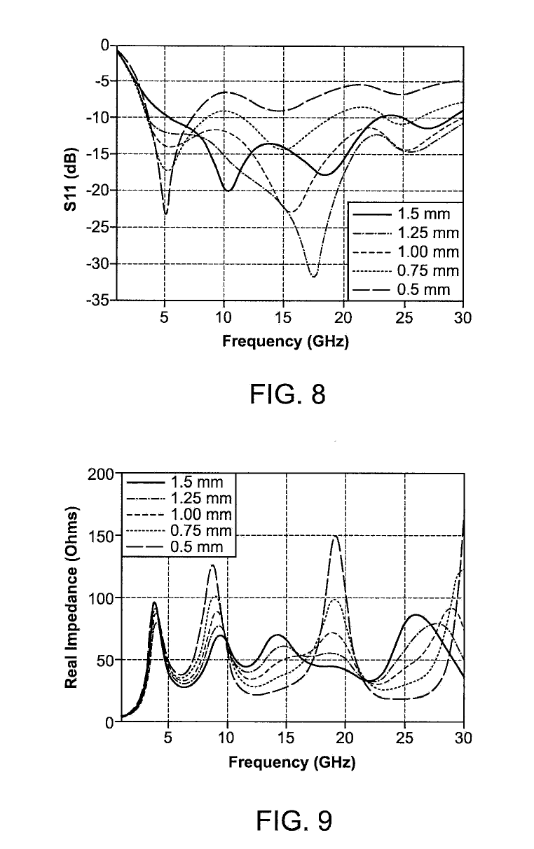

Next, after setting the taper angle θ to be 35°, gap B is then varied (with cone length A held constant). The resulting simulated S₁₁ for gap B distances of 0.5 to 1.5 mm (every 0.25 mm) is plotted in FIG. 8. From this particular data, a preferred gap B of 1 mm was selected. FIG. 9 shows the input impedance when varying gap B from 0.5 to 1 mm, thereby decreasing the periodic maximums and improving the impedance matching. After 1 mm, the periodic maximums become progressively larger and the lowest frequency of operation progressively increases with gap distance.

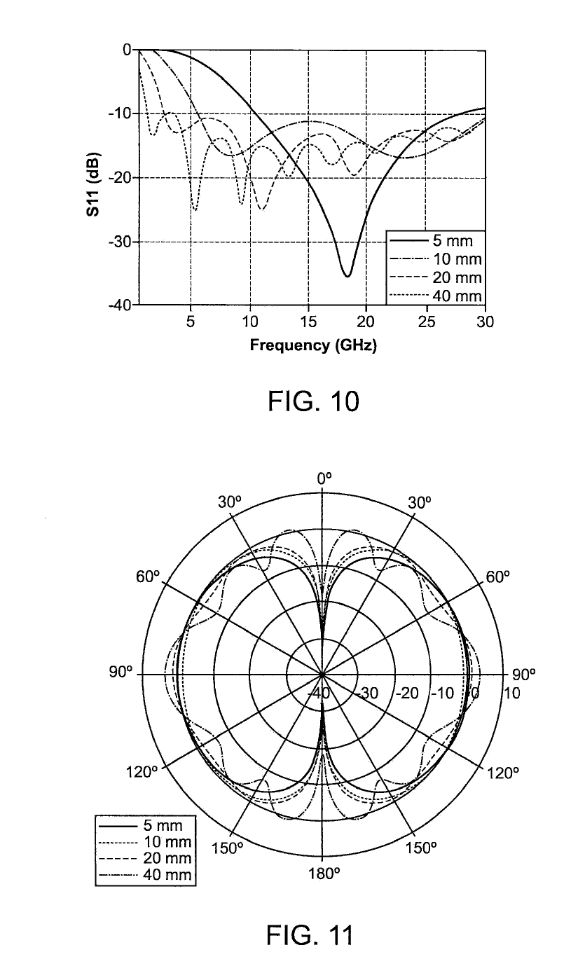

Next, after setting the taper angle θ to be 35° and the gap B to be 1 mm, cone length A is chosen. FIG. 10 illustrates the simulated S₁₁of the antenna 100 as cone length A is varied. As can be seen, the lowest useful frequency of operation depends upon cone length A. For a cone length of 5 mm, the lowest useful frequency is 11 GHz. For a cone length of 10 mm, the lowest useful frequency is 5.5 GHz. Generally speaking, as the cone length doubles, the lowest frequency of operation decreases by half.

Increasing cone length A to meet impedance matching causes the antenna gain patterns to suffer at higher frequencies. FIG. 11 illustrates simulated gain patterns at 10 GHz as the value of cone length A was increased from 5 mm to 40 mm. As can be seen, once cone length A approaches 40 mm, at least 8 dB of variation across the main lobe occurs. To lessen dispersive effects of the of the antenna and reduce its physical height, three novel reduction techniques were applied, as follows.

First, as seen in FIG. 12, bottom cone 30 of antenna 10 was placed onto a ground plane 40 of radius C. The presence of ground plane 40 enhances the bandwidth of antenna 10. Specifically, as shown in FIG. 13, as radius C is increased, the lowest frequency of operation decreases from 3.6 Ghz to 2.15 GHz at 60 mm. As the radius passes 60 mm, little effect on the impedance bandwidth is seen. For an infinite ground plate, the lowest frequency of operation is 2.1 GHz. As can therefore be seen, a large ground plate can dramatically reduce the lowest frequency of operation. Conversely, small ground planes of less than 30 mm reduce the impedance bandwidth. For a radius of 20 mm, the lowest frequency of operation is increased to 5 GHz. Thus, ground plates between 0 mm and 30 mm decrease the useful bandwidth of the antenna while a ground plane with a radius C of 30 mm or greater increases the bandwidth.

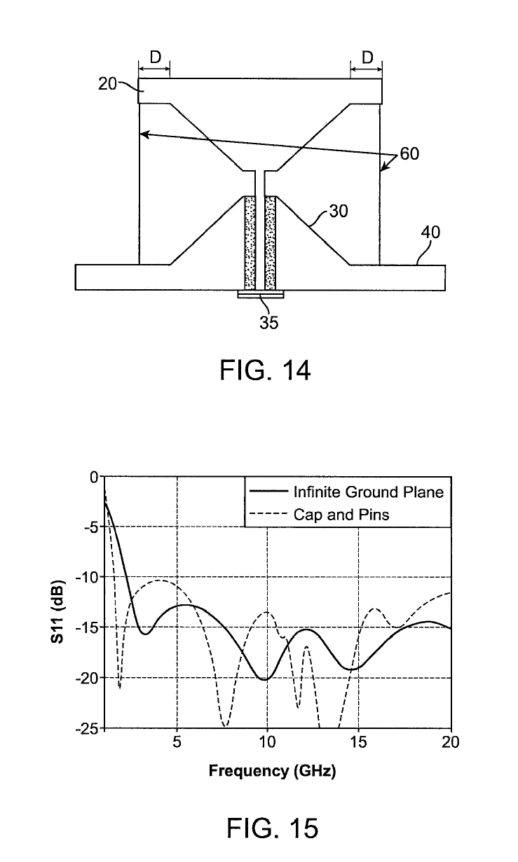

Next, as seen in FIG. 14, four shorting pins 60 were added. By adding a top cone 20 of radius 15 mm, the lowest frequency of operation was reduced from 2.15 GHz to 1.45 GHz. Simulated S₁₁ results for this system are shown in FIG. 15.

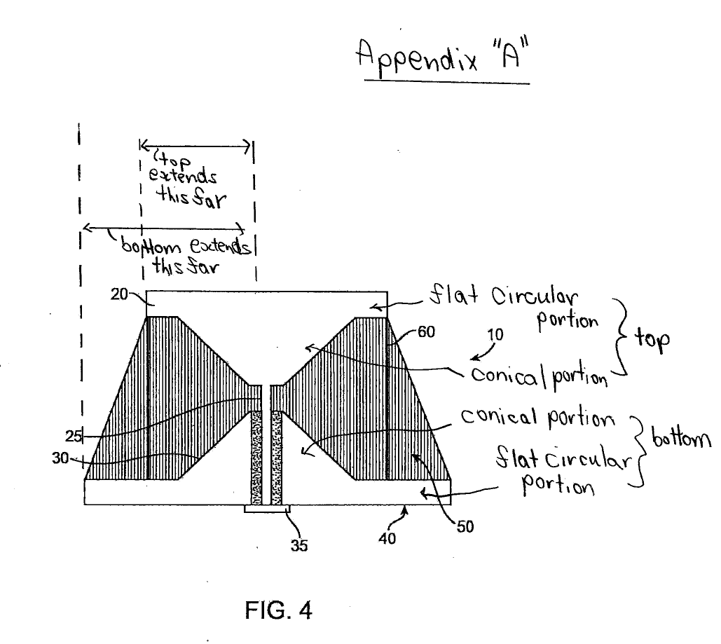

Next, as seen in FIG. 4, the region between top cone 20 and bottom cone 30 is filled with a dielectric 50. In the embodiment of the invention built and tested by the present inventor, the dielectric was polypropylene (having a dielectric constant of 2.2). It is to be understood, however, that the present invention is not limited to any particular dielectric material or materials.

Note: FIG. 4 illustrates the dimensions of the present invention as built and tested by the inventor. It is to be understood that these dimensions are merely exemplary and that the present invention as set forth in the claims is not limited to any particular absolute or relative dimensions. However, the embodiment of the invention as built by the inventor had a final total vertical height of only 15 mm and a total radius of only 53 mm. As can be concluded, the present invention is ideally suited for providing a very small antenna.

In its preferred embodiments, the laterally extending ground plate is circular. In preferred embodiments, the antenna has a total vertical height of 15 mm and a total radius of 53 mm. In one preferred embodiment, the shorting pins comprise bolts that easy mounting on any desired structure.

A further advantage of the present system is that it can be made by low cost plastic injection molding and dipping. Specifically, standard grade polypropylene was used to mold the plastic parts—which were then masked and dipped in DuPont Series 6002 Microelectronics Paste. The parts were then dried, the masking removed, and the entire assembly was thermally cured in air at 150° C. After curing, both an SMA (SubMiniature version A) coaxial RF connector 35 and shorting pins 60 were inserted. The completed system is shown in FIGS. 1 to 4.

Finally, the system was tested using an Agilent E8364B PNA Network Analyzer. Both the measured and simulated S parameters are shown in FIG. 16. From the measured data, the antenna has a useable input bandwidth starting at 3 GHz which continues past 11 GHz. The VSWR (Voltage Standing Wave Ratio) of the system is shown in FIG. 17. This bandwidth more than satisfies the needs of the UWB communication protocol.

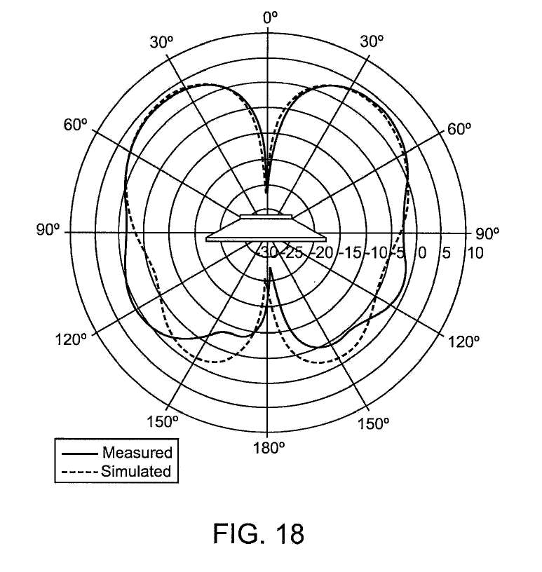

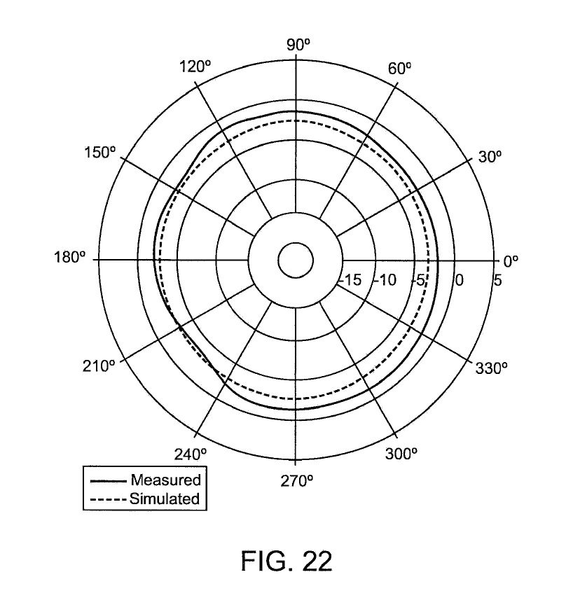

Lastly, gain patterns of the system were measured. Elevation gain patterns are shown in FIGS. 18 to 21 and azimuthal gain patterns are shown in FIGS. 22 to 25.

As can be seen, two nulls exist in the radiation pattern, being directly above and directly below the antenna. As such, the energy is focused slightly above the azimuthal plane across the entire frequency band. The later helps to keep energy from being radiated directly into the head of a used when the antenna is mounted onto a helmet. But as can be seen, the present antenna can be easily mounted onto many other existing structures, or integrated into new systems.

1. A bicone antenna, comprising:
a tapered top cone comprising a conical portion and a flat circular portion extending radially outwardly from the conical portion;
a tapered bottom cone comprising a conical portion and a flat circular portion extending radially outwardly from the conical portion;
at least one shorting pin connecting the tapered top cone and the tapered bottom cone;
a laterally extending ground plate beneath the tapered bottom cone, wherein the laterally extending ground plate is formed integral to the tapered bottom cone from a continuous block of material, such that the bottom of the bicone antenna is wider than the top of the bicone antenna;
a central pin connected to the tapered top cone, wherein the top and bottom cones are symmetrical around the central pin;
a coaxial feed connected to central pin and to the laterally extending ground plate; and
a dielectric disposed between the tapered top cone and the tapered bottom cone, and wherein the flat circular portion of the bottom cone extends radially outwardly a greater distance than the flat circular portion of the top cone.

2. The bicone antenna of claim 1, wherein the dielectric comprises one of the following group consisting of polypropylene, polyethylene, acrylonitrile butadiene styrene, and polystyrene.

3. The bicone antenna of claim 1, wherein the laterally extending ground plate is circular.

4. The bicone antenna of claim 1, wherein the top and bottom cones and the central pin comprises one of the following group consisting of copper, aluminum, brass and silver.

5. The bicone antenna of claim 1, wherein the at least one shorting pins comprise four shorting pins positioned at 90° intervals around a central axis of the bicone antenna.

6. The bicone antenna of claim 1, wherein the top and bottom cones have a taper angle from 15 to 35 degrees.

7. The bicone antenna of claim 1, wherein the bicone antenna has a height less than 20 mm.

8. The bicone antenna of claim 1, wherein the laterally extending ground plate has a diameter less than 65 mm.

9. (canceled)

10. (canceled)

11. (canceled)

12. A bicone antenna, comprising:
a tapered top cone comprising a conical portion and a flat circular portion extending radially outwardly from the conical portion;
a tapered bottom cone comprising a conical portion and a flat circular portion extending radially outwardly from the conical portion;
at least one shorting pin connecting the tapered top cone and the tapered bottom cone;
a laterally extending ground plate beneath the tapered bottom cone, wherein the laterally extending ground plate is formed integral to the tapered bottom cone from a continuous block of material, and no laterally extending ground plate above the tapered top cone such that the bottom of the bicone antenna is wider than the top of the bicone antenna;
a central pin connected to the tapered top cone, wherein the top and bottom cones are symmetrical around the central pin; and
a coaxial feed connected to central pin and to the laterally extending ground plate and wherein the flat circular portion of the bottom cone extends radially outwardly a greater distance than the flat circular portion of the top cone.

13. The bicone antenna of claim 12, further comprising:
a dielectric disposed between the tapered top cone and the tapered bottom cone.
